(19) United States
(12) Patent Application Publication
(10) Pub. No.: US 2025/0200639 A1
(43) Pub. Date: Jun. 19, 2025

(54) SYSTEMS AND METHODS FOR EXECUTING SEARCH QUERIES BASED ON DYNAMIC TAGGING

(71) Applicant: Ronati LLC, Largo, FL (US)

(72) Inventors: Stacey Tiveron Schlaich, Clearwater, FL (US); Edward Michael Cutone, III, Pittsburgh, PA (US); Brandon L. Heess, Encinitas, CA (US)

(73) Assignee: Ronati LLC, Largo, FL (US)

(21) Appl. No.: 19/063,140

(22) Filed: Feb. 25, 2025

Related U.S. Application Data
(63) Continuation of application No. 18/095,210, filed on Jan. 10, 2023, now abandoned.
(60) Provisional application No. 63/298,160, filed on Jan. 10, 2022.

(51) Int. Cl. G06Q 30/0601; G06F 16/2457; G06F 16/248; G06F 16/28; G06Q 10/087

(52) U.S. Cl. CPC G06Q 30/0631; G06F 16/2457; G06F 16/248; G06F 16/285; G06Q 10/087

(57) ABSTRACT

The present solution relates to an improved system and method for executing search requests in data structures based on electronic tag matching. The method can include maintaining a product data structure including a plurality of products and receiving, from the client device, a query comprising at least one of an image or a text string. The method can also include generating a plurality of first tags according to a tag policy from the query and identifying one or more candidate products of the plurality of products. The method can also include identifying one or more candidate first entities associated with the one or more candidate products and providing for presentation at the client device an identification of the one or more candidate products and the corresponding candidate first entities.

### CROSS-REFERENCE TO RELATED APPLICATION

This application claims the benefit of priority under 35 U.S.C. § 120 as a continuation of U.S. patent application Ser. No. 18/095,210, filed Jan. 10, 2023, which is a continuation of U.S. Provisional Patent Application No. 63/298,160, filed on Jan. 10, 2022, the disclosures of which are incorporated herein by reference in their entirety.

### TECHNICAL FIELD

The present disclosure relates to methods and systems for processing search requests based on electronic tag matching, automatically updating data structures based on electronic tags, attributing actions to entities in a hierarchical relationship, and managing requests generated via an electronic inspiration gallery.

### BACKGROUND

Existing electronic transaction systems typically are designed to handle transactions associated with products for which there is a large number of available items. However, such systems may be unable to effectively identify unique products for which there may be a relatively low supply in response to an electronic query for such products. For example, only a small fraction of the art and collectibles market is typically transacted online because the market may be antiquated, fragmented and filled with friction; buyers and sellers may miss one another constantly both online and offline; and commerce solutions may be merely online versions of the offline experience.

### SUMMARY

According to one aspect of the disclosure, a method for executing search requests in data structures based on electronic tag matching, includes maintaining, by one or more processors of an inventory management system and a product data structure including a plurality of products. Each product can be associated with a first entity. Each product can be assigned a plurality of product tags based on input information including at least one of an image of the product or information regarding the product provided by the associated first entity. The product tags can be assigned to each product by the inventory management system responsive to receiving the input information associated with the product via one or more communication interfaces to a plurality of third-party content servers. The inventory management system can manage a tag universe including the plurality of product tags.

In some implementations, the method includes receiving, by the one or more processors from a client device, a query including at least one of an image or a text string. The method can also include generating, by the one or more processors, a plurality of first tags according to a tag policy from the query. Each first tag of the plurality of first tags can be selected from the tag universe. The method can also include identifying, by the one or more processors, one or more candidate products of the plurality of products responsive to matching the plurality of first tags to one or more product tags assigned to the one or more candidate products. In some implementations, the method includes identifying, by the one or more processors, one or more candidate first entities associated with the one or more candidate products. The method can also include providing, by the one or more processors, for presentation at the client device responsive to the query, an identification of the one or more candidate products and the corresponding candidate first entities.

According to another aspect of the disclosure, a method for automatically updating data structures based on assigning electronic tags includes receiving, by one or more processors of an inventory management system, a request from a device associated with a first entity of a plurality of first entities to import product listings from at least one third-party content server to a product data structure maintained by the inventory management system. The product data structure can include a plurality of entries. Each entry of the plurality of entries can correspond to a respective product listing associated with a respective first entity. Each entry of the plurality of entries can correspond to one or more third-party content servers.

The method can also include establishing, by the one or more processors, responsive to the request, a communication session with the at least one third-party content server. In some implementations, the method includes receiving, by the one or more processors, a plurality of product listings associated with the first entity. Each product listing can identify a respective product and can include one or more images and one or more text strings describing the product. The method can also include assigning, by the one or more processors, for each product listing, product tags to the product based on the one or more images and text strings. Each product tag can be included in a tag universe maintained by the inventory management system. In some implementations, the method includes generating, by the one or more processors, for each product listing, an entry in the product data structure. The entry can include the one or more images and the one or more text strings, the product tags assigned to the product, a first identifier identifying the third-party content server from which the product listing was imported, and a second identifier identifying the first entity.

According to another aspect of the disclosure, a method for attributing actions to entities in a hierarchical relationship based on request generation includes maintaining, by one or more processors, a relationship data structure. The relationship data structure can include a plurality of relationships between a first entity and a plurality of second entities. The method can also include receiving, by the one or more processors, from a client device, a first request for one or more products. The first request can include an identifier identifying the first entity and can be generated via a script executing on an information resource of the first entity.

In some implementations, the method includes determining, by the one or more processors, one or more product tags from the request. The method can also include identifying, by the one or more processors, responsive to the request, a subset of the plurality of second entities using the one or more product tags and the identifier identifying the first entity. In some implementations, the method includes transmitting, by the one or more processors, to each second entity of the subset of the plurality of second entities, a second request based on the first request. The method can also include receiving, by the one or more processors from one of the client device or a respective second entity of the subset, a third request to perform an electronic transaction for a product corresponding to the respective second entity. The third request can identify the client device, the respective second entity, and the product.

In some implementations, the method includes determining, by the one or more processors, that the third request is associated with the first entity based on the client device, the respective second entity, and the product identified in the third request. The method can also include receiving, by the one or more processors, an indication of execution of the electronic transaction corresponding to the third request. In some implementations, the method includes updating, by the one or more processors, a data structure to attribute the electronic transaction to the first entity. Attributing the electronic transaction to the first entity can be responsive to determining that the electronic transaction for the product between the client device and the respective second entity originated from the first request generated via the script executing on the information resource of the first entity.

According to another aspect of the disclosure, a method for managing requests generated via an electronic inspiration gallery can include providing, by one or more processors of an inventory management system, to a client device, an information resource hosted on one or more servers of the inventory management system. The information resource can include an image provided by an image source entity. The information resource can be encoded to identify one or more products included in the image. The information resource can include a script, which when executed, causes the client device to generate a first request to identify products related to a first product of the one or more products to the inventory management system.

The method can also include receiving, by the one or more processors from the client device, the first request to identify products related to the first product. The first request can identify the first product, information identifying an account associated with the client device, and information identifying the image source entity. In some implementations, the method can include transmitting, by the one or more processors responsive to receiving the first request, to each of a subset of selling entities associated with the inventory management system that are selected based on a product type of the first product, a respective second request to identify products related to the first product. The method can also include receiving, by the one or more processors, from a selling entity of the subset, a response to a respective second request, the response identifying at least one related product.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising local machines in communication with remote machines;

FIGS. 1B-1D are block diagrams depicting embodiments of computers useful in connection with the methods and systems described herein;

FIG. 2 is a block diagram of a data management environment;

FIG. 3 is a block diagram of the product data structure as shown in the data management environment, according to the implementation of FIG. 2;

FIG. 4 is a block diagram of the find engine as shown in the data management environment, according to the implementation of FIG. 2;

FIG. 5 is a flow chart depicting a method for executing search requests in data structures based on electronic tag matching, according to the implementation of FIG. 2;

FIG. 6 is a flow chart depicting a method for automatically updating data structures based on assigning electronic tags, according to the implementation of FIG. 2;

FIG. 7 is a flow chart depicting a method for managing requests generated via an electronic inspiration gallery, according to the implementation of FIG. 2;

FIG. 8 is a block diagram of a syndicate lead tracking environment; and

FIG. 9 is a flow chart syndicate lead tracking, according to the implementation of FIG. 8.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following enumeration of the sections of the specification and their respective contents may be helpful:
Section A describes a network and computing environment which may be useful for practicing embodiments described herein;
Section B describes embodiments of systems and methods for cloud based inventory management;
Section C describes embodiments of systems and methods for managing requests generated via an electronic inspiration gallery; and
Section D describes embodiments of systems and methods for attributing actions to entities in a hierarchical relationship based on request generation.

### A. Network and Computing Environment

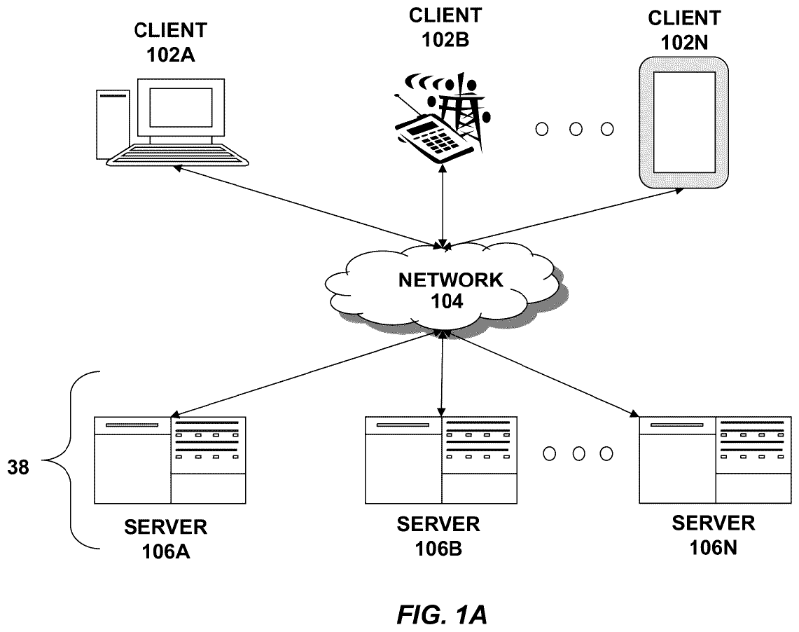

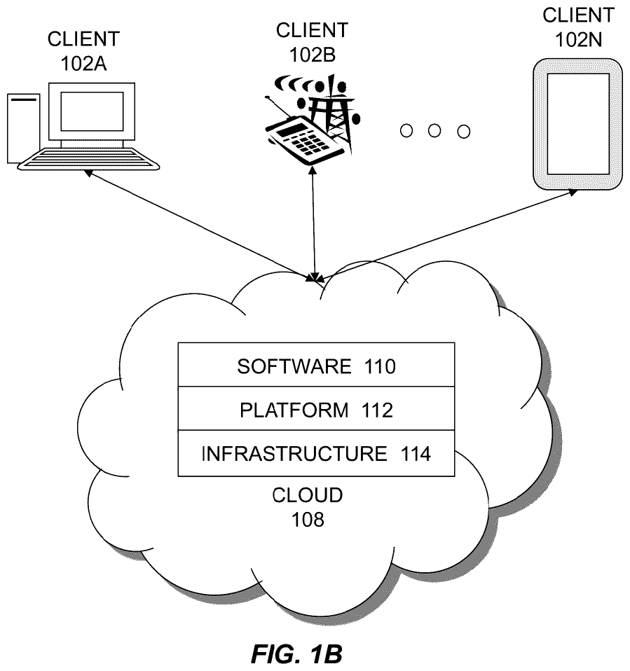

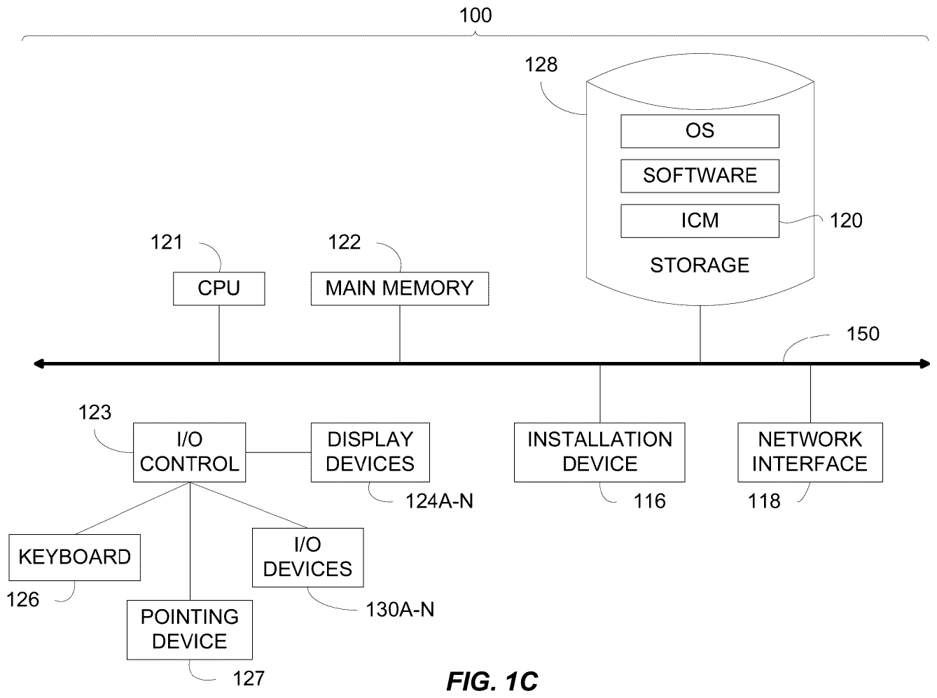

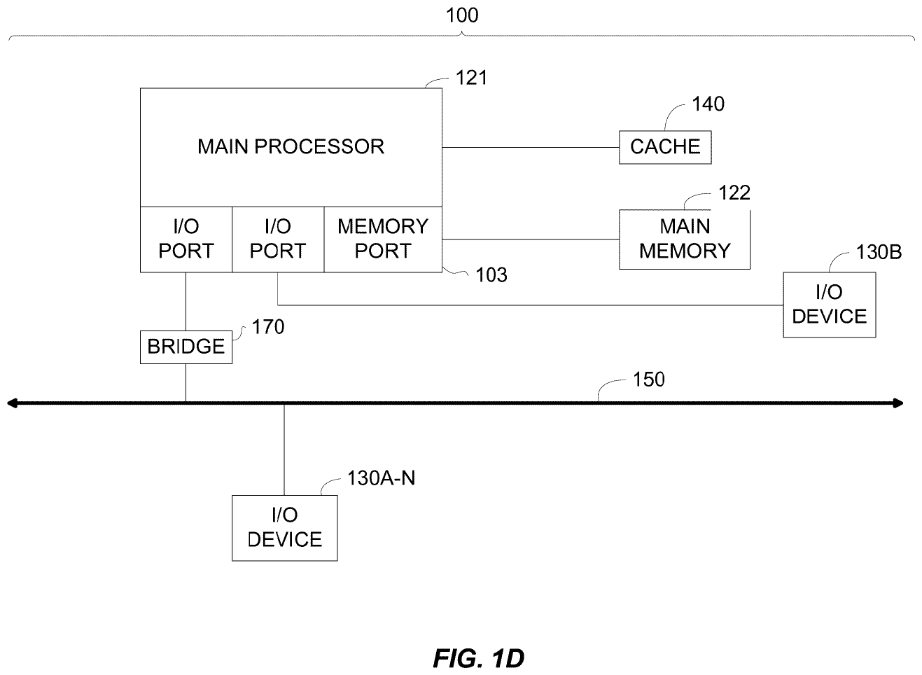

Prior to discussing the specifics of embodiments of the systems and methods, it may be helpful to discuss the network and computing environments in which such embodiments may be deployed, including a description of components and features suitable for use in the present systems and methods. FIG. 1A illustrates one embodiment of a computing environment 101 that includes one or more client machines 102A-102N (generally referred to herein as “client machine(s) 102”) in communication with one or more servers 106A-106N (generally referred to herein as “server(s) 106”). Installed in between the client machine(s) 102 and server(s) 106 is a network.

In one embodiment, the computing environment 101 can include an appliance installed between the server(s) 106 and client machine(s) 102. This appliance can manage client/server connections, and in some cases can load balance client connections amongst a plurality of backend servers. The client machine(s) 102 can in some embodiment be referred to as a single client machine 102 or a single group of client machines 102, while server(s) 106 may be referred to as a single server 106 or a single group of servers 106. In one embodiment a single client machine 102 communicates with more than one server 106, while in another embodiment a single server 106 communicates with more than one client machine 102. In yet another embodiment, a single client machine 102 communicates with a single server 106.

A client machine 102 can, in some embodiments, be referenced by any one of the following terms: client machine(s) 102; client(s); client computer(s); client device(s); client computing device(s); local machine; remote machine; client node(s); endpoint(s); endpoint node(s); or a second machine. The server 106, in some embodiments, may be referenced by any one of the following terms: server(s), local machine; remote machine; server farm(s), host computing device(s), or a first machine(s).

The client machine 102 can in some embodiments execute, operate or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions. Still other embodiments include a client device 102 that displays application output generated by an application remotely executing on a server 106 or other remotely located machine. In these embodiments, the client device 102 can display the application output in an application window, a browser, or other output window. In one embodiment, the application is a desktop, while in other embodiments the application is an application that generates a desktop.

The computing environment 101 can include more than one server 106A-106N such that the servers 106A-106N are logically grouped together into a server farm 106. The server farm 106 can include servers 106 that are geographically dispersed and logically grouped together in a server farm 106, or servers 106 that are located proximate to each other and logically grouped together in a server farm 106. Geographically dispersed servers 106A-106N within a server farm 106 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments the server farm 106 may be administered as a single entity, while in other embodiments the server farm 106 can include multiple server farms 106.

In some embodiments, a server farm 106 can include servers 106 that execute a substantially similar type of operating system platform (e.g., WINDOWS 7 or 8, manufactured by Microsoft Corp. of Redmond, Washington, UNIX, LINUX, or OS X.) In other embodiments, the server farm 106 can include a first group of servers 106 that execute a first type of operating system platform, and a second group of servers 106 that execute a second type of operating system platform. The server farm 106, in other embodiments, can include servers 106 that execute different types of operating system platforms.

The server 106, in some embodiments, can be any server type. In other embodiments, the server 106 can be any of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server 106 executing an active directory; or a server 106 executing an application acceleration program that provides firewall functionality, application functionality, or load balancing functionality. In some embodiments, a server 106 may be a RADIUS server that includes a remote authentication dial-in user service. Some embodiments include a first server 106A that receives requests from a client machine 102, forwards the request to a second server 106B, and responds to the request generated by the client machine 102 with a response from the second server 106B. The first server 106A can acquire an enumeration of applications available to the client machine 102 and well as address information associated with an application server 106 hosting an application identified within the enumeration of applications. The first server 106A can then present a response to the client's request using a web interface, and communicate directly with the client 102 to provide the client 102 with access to an identified application.

Client machines 102 can, in some embodiments, be a client node that seeks access to resources provided by a server 106. In other embodiments, the server 106 may provide clients 102 or client nodes with access to hosted resources. The server 106, in some embodiments, functions as a master node such that it communicates with one or more clients 102 or servers 106. In some embodiments, the master node can identify and provide address information associated with a server 106 hosting a requested application, to one or more clients 102 or servers 106. In still other embodiments, the master node can be a server farm 106, a client 102, a cluster of client nodes 102, or an appliance.

One or more clients 102 and/or one or more servers 106 can transmit data over a network 104 installed between machines and appliances within the computing environment 101. The network 104 can comprise one or more sub-networks, and can be installed between any combination of the clients 102, servers 106, computing machines and appliances included within the computing environment 101. In some embodiments, the network 104 can be: a local-area network (LAN); a metropolitan area network (MAN); a wide area network (WAN); a primary network 104 comprised of multiple sub-networks 104 located between the client machines 102 and the servers 106; a primary public network 104 with a private sub-network 104; a primary private network 104 with a public sub-network 104; or a primary private network 104 with a private sub-network 104. Still further embodiments include a network 104 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; or a network 104 that includes a wireless link where the wireless link can be an infrared channel or satellite band. The network topology of the network 104 can differ within different embodiments, possible network topologies include: a bus network topology; a star network topology; a ring network topology; a repeater-based network topology; or a tiered-star network topology. Additional embodiments may include a network 104 of mobile telephone networks that use a protocol to communicate among mobile devices, where the protocol can be any one of the following: AMPS; TDMA; CDMA; GSM; GPRS UMTS; 3G; 4G; or any other protocol able to transmit data among mobile devices.

Illustrated in FIG. 1B is an embodiment of a computing device 100, where the client machine 102 and server 106 illustrated in FIG. 1A can be deployed as and/or executed on any embodiment of the computing device 100 illustrated and described herein. Included within the computing device 100 is a system bus 150 that communicates with the following components: a central processing unit 121; a main memory 122; storage memory 128; an input/output (I/O) controller 123; display devices 124A-124N; an installation device 116; and a network interface 118. In one embodiment, the storage memory 128 includes: an operating system, software routines, and an interactive content module (ICM) 120. The I/O controller 123, in some embodiments, is further connected to a key board 126, and a pointing device 127. Other embodiments may include an I/O controller 123 connected to more than one input/output device 130A-130N.

FIG. 1C illustrates one embodiment of a computing device 100, where the client machine 102 and server 106 illustrated in FIG. 1A can be deployed as and/or executed on any embodiment of the computing device 100 illustrated and described herein. Included within the computing device 100 is a system bus 150 that communicates with the following components: a bridge 170, and a first I/O device 130A. In another embodiment, the bridge 170 is in further communication with the main central processing unit 121, where the central processing unit 121 can further communicate with a second I/O device 130B, a main memory 122, and a cache memory 140. Included within the central processing unit 121, are I/O ports, a memory port 103, and a main processor.

Embodiments of the computing machine 100 can include a central processing unit 121 characterized by any one of the following component configurations: logic circuits that respond to and process instructions fetched from the main memory unit 122; a microprocessor unit, such as: those manufactured by Intel Corporation; those manufactured by Motorola Corporation; those manufactured by Transmeta Corporation of Santa Clara, California; the RS/6000 processor such as those manufactured by International Business Machines; a processor such as those manufactured by Advanced Micro Devices; or any other combination of logic circuits. Still other embodiments of the central processing unit 122 may include any combination of the following: a microprocessor, a microcontroller, a central processing unit with a single processing core, a central processing unit with two processing cores, or a central processing unit with more than one processing core.

While FIG. 1C illustrates a computing device 100 that includes a single central processing unit 121, in some embodiments the computing device 100 can include one or more processing units 121. In these embodiments, the computing device 100 may store and execute firmware or other executable instructions that, when executed, direct the one or more processing units 121 to simultaneously execute instructions or to simultaneously execute instructions on a single piece of data. In other embodiments, the computing device 100 may store and execute firmware or other executable instructions that, when executed, direct the one or more processing units to each execute a section of a group of instructions. For example, each processing unit 121 may be instructed to execute a portion of a program or a particular module within a program.

In some embodiments, the processing unit 121 can include one or more processing cores. For example, the processing unit 121 may have two cores, four cores, eight cores, etc. In one embodiment, the processing unit 121 may comprise one or more parallel processing cores. The processing cores of the processing unit 121 may in some embodiments access available memory as a global address space, or in other embodiments, memory within the computing device 100 can be segmented and assigned to a particular core within the processing unit 121. In one embodiment, the one or more processing cores or processors in the computing device 100 can each access local memory. In still another embodiment, memory within the computing device 100 can be shared amongst one or more processors or processing cores, while other memory can be accessed by particular processors or subsets of processors. In embodiments where the computing device 100 includes more than one processing unit, the multiple processing units can be included in a single integrated circuit (IC). These multiple processors, in some embodiments, can be linked together by an internal high speed bus, which may be referred to as an element interconnect bus.

In embodiments where the computing device 100 includes one or more processing units 121, or a processing unit 121 including one or more processing cores, the processors can execute a single instruction simultaneously on multiple pieces of data (SIMD), or in other embodiments can execute multiple instructions simultaneously on multiple pieces of data (MIMD). In some embodiments, the computing device 100 can include any number of SIMD and MIMD processors.

The computing device 100, in some embodiments, can include an image processor, a graphics processor or a graphics processing unit. The graphics processing unit can include any combination of software and hardware, and can further input graphics data and graphics instructions, render a graphic from the inputted data and instructions, and output the rendered graphic. In some embodiments, the graphics processing unit can be included within the processing unit 121. In other embodiments, the computing device 100 can include one or more processing units 121, where at least one processing unit 121 is dedicated to processing and rendering graphics.

One embodiment of the computing machine 100 includes a central processing unit 121 that communicates with cache memory 140 via a secondary bus also known as a backside bus, while another embodiment of the computing machine 100 includes a central processing unit 121 that communicates with cache memory via the system bus 150. The local system bus 150 can, in some embodiments, also be used by the central processing unit to communicate with more than one type of I/O device 130A-130N. In some embodiments, the local system bus 150 can be any one of the following types of buses: a VESA VL bus; an ISA bus; an EISA bus; a MicroChannel Architecture (MCA) bus; a PCI bus; a PCI-X bus; a PCI-Express bus; or a NuBus. Other embodiments of the computing machine 100 include an I/O device 130A-130N that is a video display 124 that communicates with the central processing unit 121. Still other versions of the computing machine 100 include a processor 121 connected to an I/O device 130A-130N via any one of the following connections: HyperTransport, Rapid I/O, or InfiniBand. Further embodiments of the computing machine 100 include a processor 121 that communicates with one I/O device 130A using a local interconnect bus and a second I/O device 130B using a direct connection.

The computing device 100, in some embodiments, includes a main memory unit 122 and cache memory 140. The cache memory 140 can be any memory type, and in some embodiments can be any one of the following types of memory: SRAM; BSRAM; or EDRAM. Other embodiments include cache memory 140 and a main memory unit 122 that can be any one of the following types of memory: Static random access memory (SRAM), Burst SRAM or SynchBurst SRAM (BSRAM); Dynamic random access memory (DRAM); Fast Page Mode DRAM (FPM DRAM); Enhanced DRAM (EDRAM), Extended Data Output RAM (EDO RAM); Extended Data Output DRAM (EDO DRAM); Burst Extended Data Output DRAM (BEDO DRAM); Enhanced DRAM (EDRAM); synchronous DRAM (SDRAM); JEDEC SRAM; PC100 SDRAM; Double Data Rate SDRAM (DDR SDRAM); Enhanced SDRAM (ESDRAM); SyncLink DRAM (SLDRAM); Direct Rambus DRAM (DRDRAM); Ferroelectric RAM (FRAM); or any other type of memory. Further embodiments include a central processing unit 121 that can access the main memory 122 via: a system bus 150; a memory port 103; or any other connection, bus or port that allows the processor 121 to access memory 122.

One embodiment of the computing device 100 provides support for any one of the following installation devices 116: a CD-ROM drive, a CD-R/RW drive, a DVD-ROM drive, tape drives of various formats, USB device, a bootable medium, a bootable CD, a bootable CD for GNU/Linux distribution such as KNOPPIX®, a hard-drive or any other device suitable for installing applications or software. Applications can in some embodiments include a client agent 120, or any portion of a client agent 120. The computing device 100 may further include a storage device 128 that can be either one or more hard disk drives, or one or more redundant arrays of independent disks; where the storage device is configured to store an operating system, software, programs applications, or at least a portion of the client agent 120. A further embodiment of the computing device 100 includes an installation device 116 that is used as the storage device 128.

The computing device 100 may further include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can also be established using a variety of communication protocols (e.g., TCP/IP, IPX, SPX, NetBIOS, Ethernet, ARCNET, SONET, SDH, Fiber Distributed Data Interface (FDDI), RS232, RS485, IEEE 802.11, IEEE 802.11a, IEEE 802.11b, IEEE 802.11g, CDMA, GSM, WiMax and direct asynchronous connections). One version of the computing device 100 includes a network interface 118 able to communicate with additional computing devices 100′ via any type and/or form of gateway or tunneling protocol such as Secure Socket Layer (SSL) or Transport Layer Security (TLS), or the Citrix Gateway Protocol manufactured by Citrix Systems, Inc. Versions of the network interface 118 can comprise any one of: a built-in network adapter; a network interface card; a PCMCIA network card; a card bus network adapter; a wireless network adapter; a USB network adapter; a modem; or any other device suitable for interfacing the computing device 100 to a network capable of communicating and performing the methods and systems described herein.

Embodiments of the computing device 100 include any one of the following I/O devices 130A-130N: a keyboard 126; a pointing device 127; mice; trackpads; an optical pen; trackballs; microphones; drawing tablets; video displays; speakers; inkjet printers; laser printers; and dye-sublimation printers; or any other input/output device able to perform the methods and systems described herein. An I/O controller 123 may in some embodiments connect to multiple I/O devices 103A-130N to control the one or more I/O devices. Some embodiments of the I/O devices 130A-130N may be configured to provide storage or an installation medium 116, while others may provide a universal serial bus (USB) interface for receiving USB storage devices such as the USB Flash Drive line of devices manufactured by Twintech Industry, Inc. Still other embodiments include an I/O device 130 that may be a bridge between the system bus 150 and an external communication bus, such as: a USB bus; an Apple Desktop Bus; an RS-232 serial connection; a SCSI bus; a FireWire bus; a FireWire 800 bus; an Ethernet bus; an AppleTalk bus; a Gigabit Ethernet bus; an Asynchronous Transfer Mode bus; a HIPPI bus; a Super HIPPI bus; a SerialPlus bus; a SCI/LAMP bus; a FibreChannel bus; or a Serial Attached small computer system interface bus.

In some embodiments, the computing machine 100 can execute any operating system, while in other embodiments the computing machine 100 can execute any of the following operating systems: versions of the MICROSOFT WINDOWS operating systems; the different releases of the Unix and Linux operating systems; any version of the MAC OS manufactured by Apple Computer; OS/2, manufactured by International Business Machines; Android by Google; any embedded operating system; any real-time operating system; any open source operating system; any proprietary operating system; any operating systems for mobile computing devices; or any other operating system. In still another embodiment, the computing machine 100 can execute multiple operating systems. For example, the computing machine 100 can execute PARALLELS or another virtualization platform that can execute or manage a virtual machine executing a first operating system, while the computing machine 100 executes a second operating system different from the first operating system.

The computing machine 100 can be embodied in any one of the following computing devices: a computing workstation; a desktop computer; a laptop or notebook computer; a server; a handheld computer; a mobile telephone; a portable telecommunication device; a media playing device; a gaming system; a mobile computing device; a netbook, a tablet; a device of the IPOD or IPAD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein. In other embodiments the computing machine 100 can be a mobile device such as any one of the following mobile devices: a JAVA-enabled cellular telephone or personal digital assistant (PDA); any computing device that has different processors, operating systems, and input devices consistent with the device; or any other mobile computing device capable of performing the methods and systems described herein. In still other embodiments, the computing device 100 can be any one of the following mobile computing devices: any one series of Blackberry, or other handheld device manufactured by Research In Motion Limited; the iPhone manufactured by Apple Computer; Palm Pre; a Pocket PC; a Pocket PC Phone; an Android phone; or any other handheld mobile device. Having described certain system components and features that may be suitable for use in the present systems and methods, further aspects are addressed below.

### B. Systems and Methods for a Cloud-Based Inventory Management System

Referring to the figures generally, an inventory management system in accordance with the present disclosure can automatically process electronic transactions for one-of-a-kind products among disparate entities. As compared to existing technological systems, which handles a query requesting a product from a client device by providing an exhaustive list of products to the client device and then waiting for a user of the client device to manually parse the exhaustive list and select a specific product (which may be a relatively common product, such as a product having numerous items in inventory), the present solution can automatically identify potential products matching a query using tags generated from a query and matching those tags to tags assigned to products stored in a products data structure. In some embodiments, the query can be a search query, or more specifically, a product search query. In some embodiments, the tags can be generated based on an object detection algorithm. Although object detection algorithms can generate a very large number of tags corresponding to various attributes about the object included in an image or based on the image itself, the present solution assigns weights to tags generated from the query (or the object detection algorithm) based on the tags assigned to products in the products data structure. In this way, the search process is optimized by relying on tags of the query that can be matched to tags of the products in the product data structure. This reduces the amount of computational resources required and further increases the speed at which objects corresponding to queries can be matched to products. Similar to objects in images, tags generated from text based queries are also weighted based on the tags assigned to products in the products data structure. Furthermore, to further increase the speed of generating search results, the present solution can rely on a hierarchy of product types and attributes to assign weights to tags, which can further optimize the search process. This functionality can improve electronic transactions for one-of-a-kind products, for which little electronic information may be available regarding the products. For example, the present solution can automatically extract information in an electronic find request related to electronic tags, and match the electronic tags to tags of a continuously updated tag universe to match the find request to potential products. As such, the present solution can increase the accuracy and precision of matching find requests from client devices (e.g., from a buying entity) to products (e.g., of a selling entity).

The present solution extends beyond an indexing or search based problem. Instead, the present solution is built on and utilizes a complex tagging model that enables the systems described herein to categorize unlimited images and products automatically through image recognition, automated field completion, and predictive product categorization. The tagging model is dynamically updated as more and more data is ingested by the model. In some embodiments, the tagging model is trained using data that is obtained from web resources, databases, or other publicly and privately available data. This data can already include tags or labels assigned by the source of the data. Oftentimes, these tags or labels are incorrect or do not match the tags or labels that form part of the vernacular of the tagging model. In some embodiments, the system can compare the tags included in the data obtained from various sources to the tags in the tagging model and update the tagging model to include these tags according to a tag policy. In some embodiments, the system can compare the tags included in the data obtained from various sources to the tags in the tagging model and update the tagging model to modify existing tags based on the tags included in the data according to the tag policy. As a result, the tagging model can retroactively and dynamically update the tags assigned to a product in a product data structure based on the system updating the tagging model to include a new tag or modify an existing tag. In some embodiments, The system can include a self-fed, and self-learning module that constantly uses new identifiable tags and attributes to re-select updated information to document incomplete product tags automatically, through a probability and predictive matrix.

One of the technical challenges the present solution solves is the automatic population and completion of fields or attributes of products in a product data structure. By way of the present disclosure, the system can, using computer vision algorithms, spiders or web crawlers and machine learning, train a model to automatically update or complete attribute fields of a product in a product data structure. For instance, the present disclosure can analyze an image of a product and determine, using the proprietary machine learning models, that the image is of a particular type of dresser. If the machine learning model determines that the image corresponds to a particular type of dresser with a confidence score above a threshold, the system can assign the product as the particular type of dresser and populate one or more attributes of the product in the product data structure using attributes from other products that are also the particular type of dresser. This auto-population of attributes based on a similarity score improves on existing data management technologies because it allows for a more complete dataset and requires less image, text, or data processing because some of the attributes are inferred from other similar products versus those attributes either being left blank or populated based on additional analysis.

According to some aspects, the present disclosure includes a system and method for automatically populating and completing fields or attributes of a product in a product data structure, comprising: analyzing an image of a product to determine, using proprietary machine learning models, that the image corresponds to a particular type of product, said determination based on a confidence score above a threshold; and assigning the product as the particular type of product and populating one or more attributes of the product in the product data structure using attributes from other products that are also the particular type of product based on a similarity score.

Another technical challenge the present solution solves is the automatic assignment of new categories or subcategories of products. Relying on the confidence score of a machine learning object detection model, the system can assign certain products that are inputted into the system for classification into an uncategorized bucket. By assigning an uncategorized tag to such products, the system can reevaluate these products for a new classification if a sufficient products that are uncategorized satisfy a similarity threshold. In some embodiments, because the object detection model is continuously updated using newly available data, the object detection model may be able to classify a new product on the market based on tags assigned to the new product. The system can then feed the uncategorized products into the model again and if the model outputs that an uncategorized product matches the new product, the uncategorized product (or products) can be tagged with attributes similar to the new product. In this way, the data structure is dynamically updating and learning as new or never seen before products are fed into the model for classifying products.

According to some aspects, the present solution includes a system and method for automatically assigning new categories or subcategories of products comprising: a machine learning object detection model for assigning, to an uncategorized bucket, at least one product inputted for classification based on the at least one product not matching any existing category with a first confidence score above a threshold; feeding the at least one product into the machine learning object detection model subsequent to the object detection model being updated; determining that the at least one product now matches a category with a second confidence above the threshold; and updating a product data structure to assign the at least one product to the category. According to some aspects, the present solution includes a system and method of dynamically classifying products, comprising: receiving a product for classification; assigning an uncategorized tag to the product if the confidence score of a machine learning object detection model does not meet a threshold; reevaluating the product for a new classification if a plurality of uncategorized products satisfy a similarity threshold; and tagging the uncategorized product (or products) with attributes similar to a new product based on an output from the machine learning object detection model.

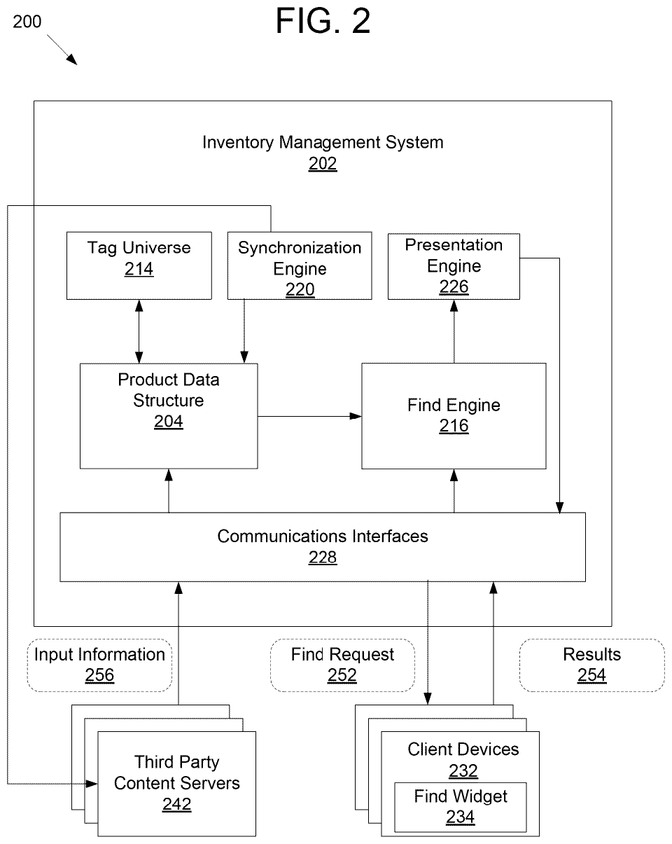

FIG. 2 is a block diagram of a data management environment 200. The data management environment 200 includes an inventory management system 202 in communication with one or more client devices 232 and one or more third party content servers 242. The communication can be through the network 104 of FIG. 1. The inventory management system 202 can include a product data structure 204, a tag universe 214, a find engine 216, a synchronization engine 220, a presentation engine 226, and a plurality of communications interfaces 228.

The inventory management system 202 can be configured to receive input information 256 from the one or more third party content servers 242. The input information 256 can include a tag request from the third party content server 242 to import a product listing from at least one of the one or more third party content servers 242. In some implementations, the tag request is from a seller device different from the third party content server 242. The input information 256 can include the product listing associated with a product from at least one of the one or more third party content servers 242. The product listing can include at least one of an image and a text string. In some implementations, the inventory management system 202 can receive the product listing as a second input information different from the input information 256 including the tag request. The inventory management system 202 can be configured to import the product listing into the product data structure 204.

The inventory management system 202 can be configured to establish a communication session with the one or more third party content servers 242 in response to receiving the tag request. In some implementations, the communication session is maintained at a transport layer using transmission control protocol (TCP). In other implementations, the communication session is maintained at an application layer using user datagram protocol (UDP).

The inventory management system 202 can be configured to receive the product listing in response to establishing a communication session with the one or more third party content servers 242. Each product listing can identify a respective product and can include at least one of one or more images and one or more text strings describing the product.

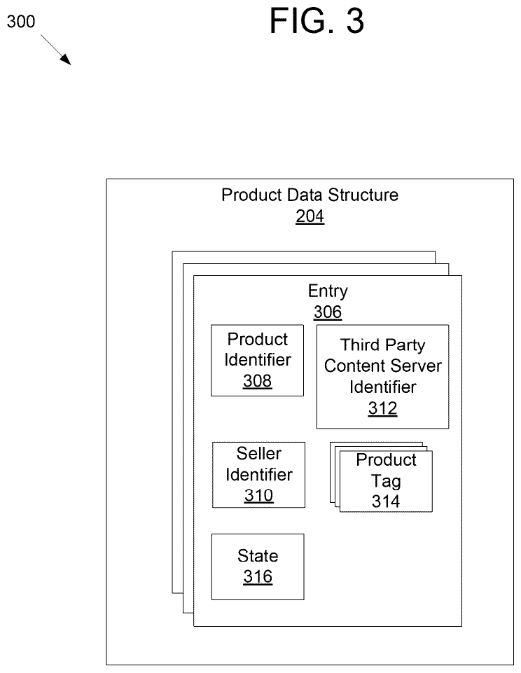

In some implementations, referring to FIG. 3, the inventory management system 202 is configured to assign a plurality of product tags 314 to each product in response to receiving the product listings from the one or more third party content servers 242. The inventory management system 202 can be configured to maintain product tags 314 in the tag universe 214. The inventory management system 202 can update products tags 314 of the tag universe 214 responsive to receiving product listings from the one or more third party content servers 242.

The inventory management system 202 can be configured to generate one or more entries 306. Each entry 306 can be representative of a product corresponding to a product listing received from the one or more third party content servers 242. As discussed below with respect to the product data structure 204, the inventory management system 202 can generate an entry 306 for each specific product (a specific make and model of a product), and assign a unique product identifier 308 to each instance (e.g., unit) of each specific product. In some implementations, the inventory management system 202 generates the one or more entries 306 in response assigning the plurality of product tags 314 to the product. The one or more entries 306 can be stored in the product data structure 204. The inventory management system 202 can be implemented as one or more processors connected to or including the product data structure 204.

### 1. Product Data Structure

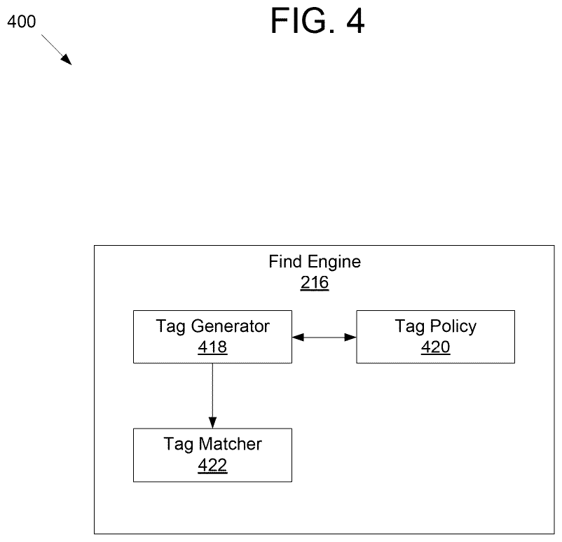

The inventory management system 202 maintains the product data structure 204 to maintain information regarding products associated with various selling entities (based on information received from third party content servers 242). As discussed below with reference to FIG. 4, the inventory management system 202 can assign a plurality of tags by executing the tag policy 420.

In some implementations, the one or more third party content servers 242 is maintained directly by a selling entity (e.g., seller) associated with the product listings. In some implementations, the one or more third party content servers 242 are maintained by third parties such as Ebay, Firstdibs, and the like, and products of the seller associated with the product listings are maintained thereon. In some implementations, the seller lists its product on its own website as well as a third party system such as Ebay. As such, information regarding products that could potentially be used for an electronic transaction may be maintained across various entities that do not have existing protocols for product listing synchronization.

FIG. 3 is a block diagram of an implementation of the product data structure 204 as shown in the data management environment 200 of FIG. 2. The product data structure 204 can be configured to store the product listing (e.g., one or more entries 306) in a structured way. The product data structure 204 can include the one or more entries 306. The inventory management system 202 can generate the product data structure 204 so that the one or more entries 306 can include a product identifier (ID) 308 associated with a product, a seller ID 310 associated with the product, a third party content server ID 312 and one or more product tags 314 associated with the product. The product ID 308 can be unique and distinguishable from other product IDs 308. The product ID 308 can uniquely identify the product to which the product ID 308 is assigned. The product ID 308 can include at least one of the image and the text string imported by the product data structure 204 as part of the product listing from the third party content server 242. The seller ID 310 can be a name or identifier of an entity such as a person or company that sells the product. The inventory management system 202 can use the seller ID 310 to uniquely identify the entity such as a person or company to which the seller ID is assigned. The inventory management system 202 can use the third party content server ID 312 to uniquely identify the third party content server 242 from which the product listing was imported. The one or more product tags 314 can be descriptors of the product. For example, the one or more product tags 314 can be a furniture type (e.g. “chair”), a color (e.g. “brown”), and a style “mid-century modern”).

Referring back to FIG. 2, the tag universe 214 can be configured to store product tags 314. The tag universe 214 can include the product tags 314 from each of the one or more entries 306 in the product data structure 204. In some implementations, the product tags 314 in the tag universe 214 can be associated with one or more pointers to one or more addresses. The addresses can be physical addresses or logical addresses. The one or more addresses can be first addresses to the one or more entries 306 of the product data structure 204.

### 2. Synchronization Engine

The inventory management system 202 uses the synchronization engine 220 to automatically update information maintained in the product data structure 204 as well as by third party content servers 242 responsive to a change in state of a product, such as when the inventory management system 202 detects that a unit of a product has been sold. In response to identifying the product associated with the seller on the third party content server 242 (e.g., by retrieving the product ID 308 of the product), or identifying a change of a state 316 of the product, the synchronization engine 220 can search the product data structure 204 to determine if that product is in the product data structure 204 (e.g., by executing a search based on the product ID 308 of the product). The inventory management system 202 can execute the synchronization engine 220 to determine whether the state 216 indicates whether the product is available for purchase or sold out. The state 216 can indicate a count of the product that is available for purchase. In response to determining that the product is stored on the product data structure 204, the synchronization engine 220 can synchronize the entry 306 in the product data structure 204 and any appropriate third party content servers 242 to match what is on the third party content server 242 that was updated. For example, responsive to determining that a product has been sold on a first third party content server 242 (e.g., Ebay), the synchronization engine 220 can decrease a count of the number of products in the entry 306 for the sold product in product data structure 204. Responsive to determining the count for a particular product to be zero (or to decrease to zero), the synchronization engine 220 can cause the product listings to be removed from other third party content servers 242 (e.g., First dibs). In response to determining that an entry 306 for the product is not stored on the product data structure 204, the inventory management system 202 can generate a new entry 306 in the product data structure 204. The synchronization engine 220 can be implemented using one or more processors of the inventory management system 202.

### 3. Find Engine

The data management environment 200 executes the find engine 216 to automatically process data requests for purchasing specific products based on information received from a requesting entity—even if the requesting entity does not have information representing the specific products, and the information received from the requesting entity does not exactly match the specific products that are maintained in the product data structure 204. The find engine 216 can be configured to receive a find request 252 from a client device 232. The find request 252 can be a query indicating features of a requested product. The query can include at least one of an image and a text string. The find engine 216 can be configured to send results 254 to the client device 232 responsive to processing the find request 252. In some implementations, the find request 252 is generated by a find widget 234 executed by the client device 232 (e.g., executed by the client device 232 when the client device 232 access an information resource implementing the find widget 234).

FIG. 4 is a block diagram of an implementation of the find engine 216 as shown in the data management environment 200 of FIG. 2. The find engine 216 can include a tag generator 418, a tag policy 420, and a tag matcher 422. The tag generator 418 can be configured to receive the query from the client device 232. In some implementations, the tag generator 418 can be configured to generate the plurality of first tags in response to receiving the query. The tag generator 418 can be configured to generate a plurality of first tags according to the tag policy 420 from the query.

The tag policy 420 can be a set of rules that the tag generator 418 uses in order to generate the plurality of first tags in response to receiving the query. The tag policy 420 can include rules for parsing text into keywords. For example, the tag generator 418 can execute the tag policy 420 to parse the text into the keywords wherever there is a space present. The tag policy 420 can include rules for classifying the keywords. For example, the tag generator 418 can include or retrieve from a database pre-defined keywords; and the tag policy 420 can include a rule that if one of the keywords matches one of the pre-defined keywords, then the tag generator 418 classifies one of the keywords as one of the plurality of first tags. The tag policy 420 can include rules for image recognition. For example, the tag policy 420 include rules that the tag generator 418 assign region descriptions for all shapes or regions in the image. The region descriptions can be defined by boundaries, texture, colors, chain codes, shape numbers, area, perimeter, or the like. The tag policy 420 can include rules that the tag generator 418 assign pattern classes to the image or to shapes or regions in the image. The pattern class can be an arrangement of the region descriptions. The tag generator 418 can include or retrieve mappings from a lookup table associating pattern classes with some of the plurality of the first tags. The tag generator 418 can be configured to generate the plurality of the first tags in response to the tag generator 418 assigning pattern classes to the image according to the tag policy 420.

The tag matcher 422 can be configured to match the plurality of the first tags to the one or more product tags 314 assigned to one or more candidate products. In some implementations, the tag matcher 422 is configured to search the product tags 314 of the tag universe 214 for the one or more product tags 314 that match with the plurality of first tags. In some implementations, the tag matcher 422 can compute one or more match scores based on the comparisons between the product tags 314 and one first tag of the plurality of first tags. In some implementations, the tag matcher 422 compares the one or more match scores to a threshold score to determine whether one or more matches is identified. In some implementations, the tag matcher 422 can perform multi-pass matching. As a result of a first-pass matching, the tag matcher 422 can determine a number of the one or more product tags 314 that matches the first tag and compare the number to a lower threshold count and a higher threshold count. If the number that matches is higher than the higher threshold count, then the tag matcher 422 can re-compute the matching scores and compare to a threshold score that is lower than the previous threshold score. If the number that matches is lower than the lower threshold count, then the tag matcher 422 can re-compute the matching scores and compare to a threshold score that is higher than the previous threshold score. The tag matcher 422 can repeat iterations of comparing the match scores to the updated threshold score until the number of one or more products tag 314 that matches the first tag is in between the lower threshold count and the higher threshold count.

The tag matcher 422 can be configured to identify one or more candidate products of the plurality of products responsive to matching the plurality of first tags to the one or more product tags 314 assigned to the one or more candidate products. The tag matcher 422 can be configured to identify one or more candidate first entities (e.g. one or more sellers corresponding to one or more seller IDs 310) associated with the one more candidate products. In some implementations, the tag matcher 422 is configured to identify the one or more candidate products and the one or more candidate first entities by looking up the addresses associated with the product tags 314 of the tag universe 214 in the lookup table.

### 4. Presentation Engine

The presentation engine 226 can be configured to send the results 254 to a buyer via the one or more client devices 232. The results 254 can include a name of the product, the product ID 308, or the seller ID 310 associated with the candidate products. The presentation engine 226 can be configured to notify a seller that the results 254 include one or more candidate products associated with the seller via the one or more third party content servers 242 so that the seller is aware that a buyer has been provided results including the one or more candidate products associated with the seller.

The presentation engine 226 can generate a notification corresponding to the results 254 based on a notification generation policy, and transmit the notification to the seller. The presentation engine 226 can execute the notification generation policy based on a notification generation selection received from the seller. For example, the inventory management system 202 can receive an input indicating the notification generation selection from a seller device associated with the seller, and execute the notification generation policy based on the notification generation selection. The presentation engine 226 can store the selection in a database entry such as the entry 306 in the product data structure 204, such that the presentation engine 226 can automatically generate the notification when retrieving the entry 306 for each candidate product. In some implementations, the presentation engine 226 includes a data structure having the database entry, wherein, the data structure of the presentation engine 226 is separate from the product data structure 204.

The presentation engine 226 can retrieve the selection from the database entry associated with the seller and/or from the entry 306 for the candidate product. Based on the retrieved selection, the presentation engine 226 executes the notification generation policy. The selection options can include automatic presentation without notification, automatic presentation with notification, and seller confirmed presentation. One of the selection options may be a default option (e.g., responsive to determining that a selection option has not been received for a particular seller, the presentation engine 226 automatically executes the notification generation policy using the default option).

In some implementations, the selection indicates automatic results presentation (without notification), such that the presentation engine 226 can transmit the results to the one or more client devices 232 without receiving approval from the seller device. As such, the seller can opt into auto-matching so that whatever match the find engine 216 comes up with can be communicated to the buyer.

In some implementations, the selection indicates automatic presentation with notification. As such, the presentation engine can transmit the results 254 to the one or more client devices 232 and also transmits the notification to the seller device, such that seller receives the notification, and sending the results 254 to the buyer is fully automatic.

In some implementations, the selection indicates seller confirmed presentation. The presentation engine 226 does not transmit the results 254 to the one or more client devices 232 unless the presentation engine 226 receives an input indicating approval from the seller device. For example, the presentation engine 226 can transmit a first notification to the seller device indicating that the results 254 include one or more candidate products associated with the seller. The presentation engine 226 can subsequently receive an indication from the seller device that the seller approves transmitting results 254 that include the one or more candidate products associated with the seller to the one or more client devices 232. The presentation engine 226 can transmit the results 254 to the one or more client devices 232 responsive to receiving the indication that the seller approves transmitting the results 254 (and can transmit a second notification to the seller device indicating that the results 254 are transmitted). As such, the seller can be notified that one or more of their products is a candidate product, and the seller can confirm or deny having their product listing exposed via the results 254 to the buyer.

The plurality of communication interfaces 228 can be configured to receive the query from the client device 232. The plurality of communication interfaces 228 can be configured receive the input information 256 from the third party content servers 242. The plurality of communication interfaces 228 can be configured to send the results 254 to one or more client devices 232. Each of the plurality of communication interfaces 228 can be implemented as the network interface 118.

The one or more client devices 232 can be used by one or more buyers. The one or more client devices 232 can be configured to send the find request 252 to the inventory management system 202. The one or more client devices 232 can be configured to receive the results 254. The one or more client devices 232 can include the find widget 234.

The one or more third party content servers 242 can be used by one or more sellers. The one or more third party content servers 242 can be configured to send the input information 256 to the inventory management system 202.

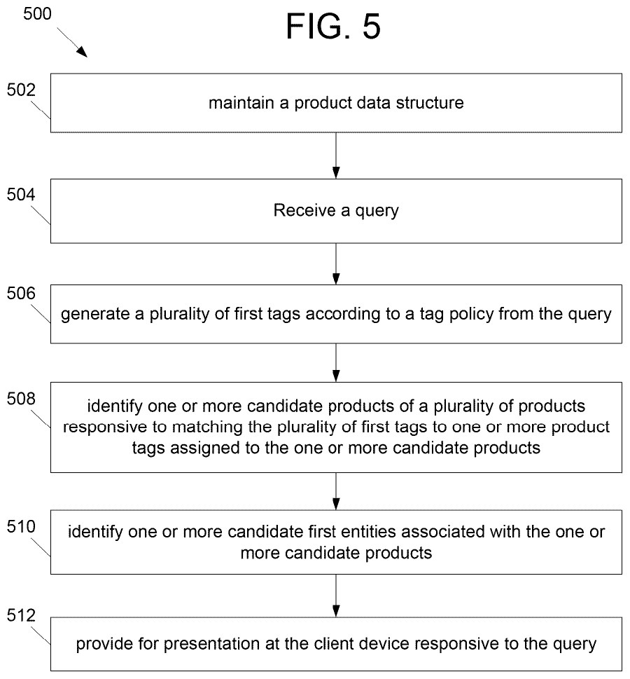

FIG. 5 is a flow chart depicting a method 500 for executing search requests in data structures based on electronic tag matching, according to the implementation of FIG. 2. As a brief overview of the method, the inventory management system 202 can maintain a product data structure 204 comprising a plurality of products (Block 502). The inventory management system 202 can receive, from the client device 232, a query comprising at least one of an image or a text string (Block 504). The inventory management system 202 can generate a plurality of first tags according to a tag policy 420 from the query (Block 506). The inventory management system 202 can identify one or more candidate products of the plurality of products (Block 508). the inventory management system 202 can identify one or more candidate first entities associated with the one or more candidate products (Block 510). The inventory management system 202 can provide for presentation at the client device 232 an identification of the one or more candidate products and the corresponding candidate first entities (Block 512).

In further detail, at block 502, the inventory management system 202 can maintain a product data structure 204 including a plurality of products, each product associated with a first entity, each product assigned a plurality of product tags 314 based on input information including at least one of an image of the product or information regarding the product provided by the associated first entity, the product tags 314 assigned to each product by the inventory management system 202 responsive to receiving the input information associated with the product via one or more communication interfaces 228 to the plurality of third-party content servers 242, the inventory management system 202 managing a tag universe 214 including the plurality of product tags 314.

At block 504, the inventory management system 202 can receive, from a client device 232, a query. The query can include at least one of an image and a text string. The inventory management system 202 can send a response to the client device 232 acknowledging receipt of the query.

At block 506, the inventory management system 202 can generate a plurality of first tags according to a tag policy 420 from the query. Each first tag of the plurality of first tags can be selected from the tag universe 214. The tag policy 420 can include rules for parsing text into keywords. The tag policy 420 can include rules for image recognition. The tag policy 420 can include rules that the tag generator 418 assign pattern classes to the image or to shapes or regions in the image. In some embodiments, the inventory management system 202 can execute an image recognition algorithm to detect objects in the image. The system 202 can then assign, to each of the objects identified, a rank or a priority based on a size or location of the object. The system can identify any of the objects as a primary object for the purposes of the query. The system can do so based on a position of the object or based on additional information provided by a user in the query.

The image recognition algorithm can then generate tags for the primary object. The tags can be based on the type of object determined by the image recognition algorithm. For instance, if the image recognition algorithm recognizes a table, the image recognition algorithm can then determine a size of the table, a color of the table, a shape of the table, among other attributes of the object. Based on these attributes, the image recognition algorithm can further determine a type of table. In some embodiments, the image recognition algorithm can determine the table type based on the attributes of the table without outputting the attributes of the table.

Based on the attributes of the table identified in the image, the system 202 can then generate a plurality of tags using those attributes. In some embodiments, the system 202 can identify attributes of the particular type of table identified by the image recognition algorithm and perform a lookup or use some alternative method to determine attributes of products corresponding to the particular type of table that are stored in the product data structure. Based on the attributes stored in the product data structure for that type of table, the system 202 can select attributes or assign weights to attributes to include in the tag query.

In some embodiments, in generating the plurality of first tags according to the tag policy from the query, the system 202 can use an object detection algorithm to identify one or more objects from the image, identify a primary object from the image, determine a type of product corresponding to the primary object, identify, using the product data structure, a plurality of attributes stored for candidate products that correspond to the determined type of product, and generate, for the primary object, a plurality of tags corresponding to the plurality of attributes responsive to identifying the plurality of attributes stored for candidate products. In some embodiments, the plurality of attributes includes a color of the product, a dimension of the product, and a time period associated with the product. In some embodiments, responsive to determining that the first object is a first product type, the system 202 can identify a first plurality of attributes and responsive to determining that the first object is a second product type, the system 202 can identify a second plurality of attributes different from the first plurality of attributes. In some embodiments, the plurality of attributes are each assigned a weight to optimize a search process. The weight can be based on one of a unique number of different values for the attribute or a frequency count of the most common value for the attribute. In some embodiments, responsive to determining that the query is a text query, the system 202 can rearrange the query according to a standard format based on the words included in the text query.

It should be noted that one of the technical challenges the present solution is designed to overcome is the sheer number of product categories, subcategories or types and for each product category, subcategory or type, the number of unique and different product attributes and corresponding values for those product attributes. Each product data structure corresponding to a single product can have over 30 attributes that are arranged according to a hierarchy. For instance, a product can fall under the category furniture, and then a subcategory seating, and then a type sectional. Then for sectionals as a type of seating, there are a plurality of attributes including a material of the sectional, height, width, depth of the sectional, weight of the sectional, a color of the upholstery, a maker or brand, a style, a period, a year, a classification, a condition, an origin, among others. For each type of product, there may be different attributes that are relevant. As such, the present solution relies on an intelligent and structured approach to assigning tags to queries based on determining a product type as different products may have different attributes that are of interest. For instance, rugs may have additional or other attributes including knot count, type of knots, hand woven or machine woven, among others.

At block 508, the inventory management system 202 can identify one or more candidate products of the plurality of products responsive to matching the plurality of first tags to one or more product tags 314 assigned to the one or more candidate products. The product ID 308 can correspond to the one or more assigned product tags 314. The product ID 308 can uniquely identify the product to which the product ID 308 is assigned.

At block 510, the inventory management system 202 can identify one or more candidate first entities associated with the one or more candidate products. The seller ID 310 can correspond to the one or more assigned product tags 314. The seller ID 310 can uniquely identify the entity such as a person or company to which the seller ID 310 is assigned.

At block 512, the inventory management system 202 can provide for presentation at the client device 232 responsive to the query, an identification of the one or more candidate products and the corresponding candidate first entities. The identification can include a name of the product, the product ID 308, or the seller ID 310 associated with the candidate products. The inventory management system 202 can notify the seller corresponding to the one or more candidate products on the one or more third party content servers 242 that a match has been found for the one or more candidate products. In some embodiments, the query can be a search query, or more specifically, a product search query.

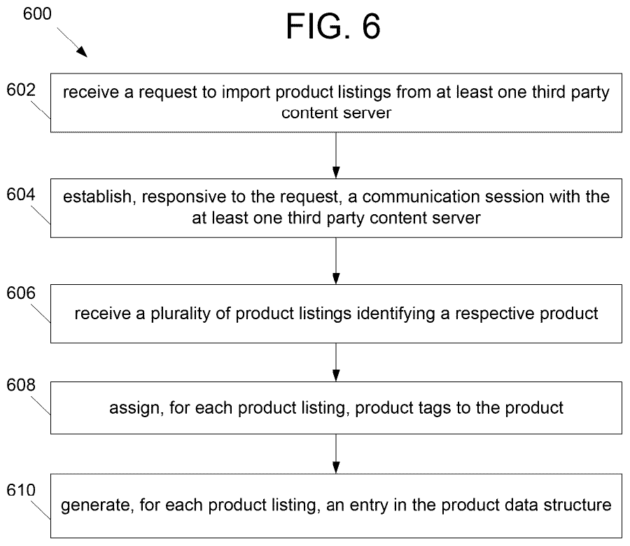

FIG. 6 is a flow chart depicting a method 600 for automatically updating data structures based on assigning electronic tags, according to the implementation of FIG. 2. As a brief overview of the method, the inventory management system 202 can receive a request to import product listings from at least one third party content server 242 to a product data structure 204 maintained by the inventory management system (block 602). The inventory management system 202 can establish, responsive to the request, a communication session with the at least one third party content server 242 (block 604). The inventory management system 202 can receive a plurality of product listings identifying a respective product (block 606). The inventory management system 202 can assign, for each product listing, product tags 314 to the product (block 608). The inventory management system 202 can generate, for each product listing, an entry 306 in the product data structure 204 (block 610).

In further detail, at block 602, the inventory management system 202 can receive a request from a device associated with a first entity of a plurality of first entities to import product listings from at least one third party content server 242 to a product data structure 204 maintained by the inventory management system. The product data structure 204 can include a plurality of entries 306. Each entry 306 of the plurality of entries 306 can correspond to a respective product listing associated with a respective first entity and corresponding to one or more third party content servers 242. In some embodiments, the device associated with the first entity is the at least one third party content server 242. In other embodiments, the device associated with the first entity is a device different from the at least one third party content server 242.

At block 604, the inventory management system 202 can establish responsive to the request, a communication session with the at least one third party content server 242. In some implementations, the communication session is maintained at a transport layer using transmission control protocol (TCP). In other implementations, the communication session is maintained at an application layer using user datagram protocol (UDP).

At block 606, the inventory management system 202 can receive a plurality of product listings associated with the first entity. Each product listing can identify a respective product and can include at least one of one or more images and one or more text strings describing the product. Receiving a plurality of product listings can be in response to establishing a communication session with the at least one third party content server 242.

At block 608, the inventory management system 202 can assign, for each product listing, product tags 314 to the product based on the one or more images and text strings. Each product tag 314 can include in a tag universe 214 maintained by the inventory management system 202. The tag universe 214 can be configured to transmit the plurality of product tags 314 to the product data structure 204 in response to the inventory management system 202 assigning the plurality of product tags 314 to the product.

At block 610, the inventory management system 202 can generate, for each product listing, an entry 306 in the product data structure 204, the entry 306 including the one or more images and the one or more text strings, the product tags 314 assigned to the product, a first identifier identifying the third party content server 242 from which the product listing was imported, and a second identifier identifying the first entity. The one or more entries 306 can be stored in the product data structure 204.

### C. Systems and Methods for Managing Requests Generated Via an Electronic Inspiration Gallery

The inventory management system 202 can be configured to provide to the client device 232 an information resource hosted on one or more servers of the inventory management system. The information resource can include an image provided by an image source entity. The image source entity can be sellers' websites, interior designers' blogs, and the like. The information resource can be encoded to identify one or more products included in the image. The information resource can include the find widget 234, which when executed, causes the client device 232 to generate a first request to identify products related to a first product of the one more products to the inventory management system 202.

The find widget 234 can be a script executable on the website that receives information corresponding to an input at the website and generates the find request 252 based on the input. The find widget 234 can run on a variety of websites such as a sellers' websites, interior designers' blogs, and the like. The find widget 234 can include a user interface of the website presented via the client device 232. The user interface can allow a user to click on an image corresponding to a product. The find widget 234 can receive the input based on the user clicking on the image. The find widget 234 can be implemented as one or more processors.

The inventory management system 202 can be configured to receive from the client device 232 the first request to identify products related to the first product, the first request identifying the first product, and information identifying an account associated with the client device 232 and identifying the image source entity. The inventory management system 202 can be configured to transmit, to each of a subset of selling entities associated with the inventory management system 202 that are selected based on a product type of the first product, a respective second request to identify products related to the first product. In some implementations, the second request has an expiration date. In response to one of the subset of selling entities not responding by the expiration date, the inventory management system 202 can determine that the one of the subset of selling entities does not have at least one related product. The inventory management system 202 can be configured to receive from a selling entity of the subset a response to a respective second request, the response identifying at least one related product.

The inventory management system 202 can be configured to transmit a notification to the client device 232 indicating a match to the first product. The match can include a score representing how closely matched the related product is to the first product. The score can be based off of characteristics of the first product, such as the product type, color, style, year it was designed, year it was manufactured. The inventory management system 202 can be configured to update a data structure to identify the at least one related product to the first product. The data structure can include the product data structure 204.

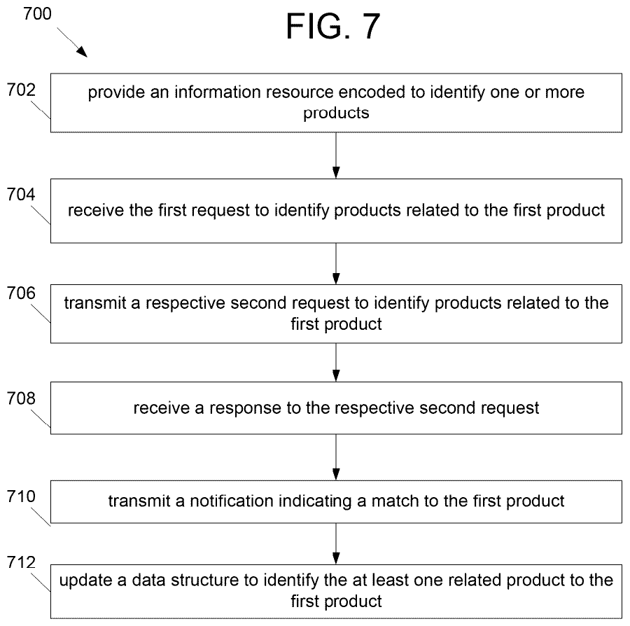

FIG. 7 is a flow chart depicting a method 700 for managing requests generated via an electronic inspiration gallery, according to the implementation of FIG. 2. As a brief overview of the method, the inventory management system 202 can provide an information resource facilitating generation of a first request to identify products related to a first product (block 702). The inventory management system 202 can receive the first request to identify products related to the first product (block 704). The inventory management system 202 can transmit a respective second request to identify products related to the first product (block 706). The inventory management system 202 can receive a response to the respective second request (block 708). The inventory management system 202 can transmit a notification indicating a match to the first product (block 710). The inventory management system 202 can update a data structure to identify the at least one related product to the first product (block 712).

In further detail, at block 702, the inventory management system 202 can provide to a client device 232, an information resource hosted on one or more servers of the inventory management system 202. The information resource can include an image provided by an image source entity. The information resource can be encoded to identify one or more products included in the image. The information resource can include a script, which when executed, causes the client device 232 to generate a first request to identify products related to a first product of the one or more products to the inventory management system 202. The script can be a find widget 234.

At block 704, the inventory management system 202 can receive, from the client device 232, the first request to identify products related to the first product. The first request can identify the first product, information identifying an account associated with the client device 232, and information identifying the image source entity. In some embodiments, the first request can identify the image source entity. The first request can include the image provided by the image source entity.

At block 706, the inventory management system 202 can transmit, responsive to receiving the first request, to each of a subset of selling entities associated with the inventory management system 202 that are selected based on a product type of the first product, a respective second request to identify products related to the first product. In some implementations, the second request has an expiration date. In response to one of the subset of selling entities not responding by the expiration date, the inventory management system 202 can determine that the one of the subset of selling entities does not have at least one related product.

At block 708, the inventory management system 202 can receive, from a selling entity of the subset, a response to the respective second request. The response can identify at least one related product. The response can include at least one of one or more images and one or more text strings.

At block 710, the inventory management system 202 can transmit a notification to the client device 232 indicating a match to the first product. The match can include a score representing how closely matched the related product is to the first product. The score can be based off of characteristics of the first product, such as the product type, color, style, year it was designed, year it was manufactured.

At block 712, the inventory management system 202 can update a data structure to identify the at least one related product to the first product. The data structure can include the product data structure 204. The data structure can include remote data structures, such as on sellers' websites, interior designers' blogs, and the like.

### D. Systems and Methods for Attributing Actions to Entities in a Hierarchical Relationship Based on Request Generation

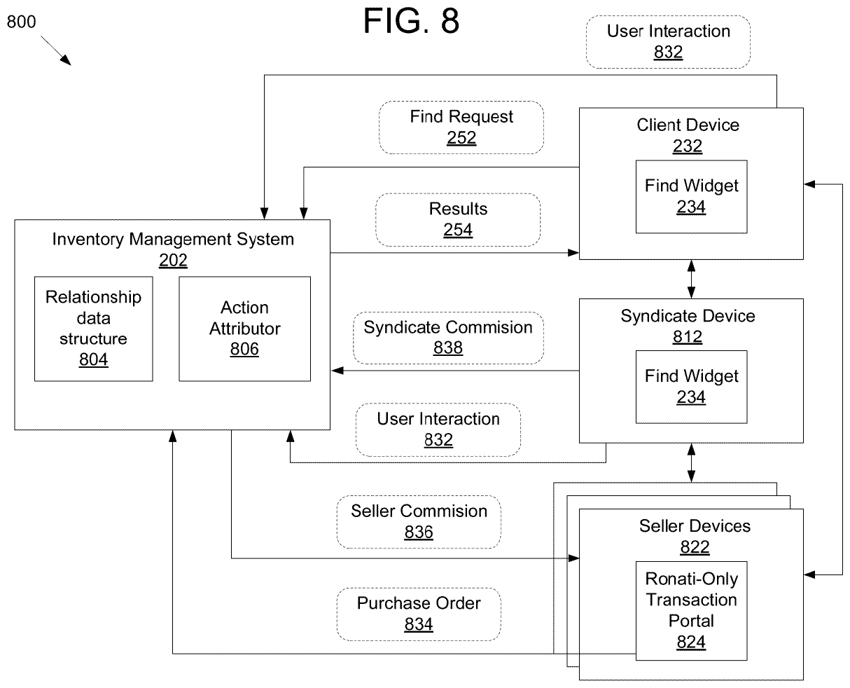

FIG. 8 is a block diagram of a syndicate lead tracking environment 800. The syndicate lead tracking environment 800 can include an inventory management system 202, client device 232, syndicate device 812, and one or more seller devices 822. The inventory management system 202, the client device 232, the syndicate device 812, and the one or more seller devices 822 can be coupled to each other. Each syndicate device 812 corresponds to a syndicate. Each seller device 822 corresponds to a seller. The syndicate device 812 and each seller device 822 are also known as entities.

The inventory management system 202 can include a relationship data structure 804 and an action attributor 806. The inventory management system 202 can include the blocks which are included in the implementation of the inventory management system 202 in FIG. 2. The inventory management system 202 can be configured to maintain the relationship data structure 804 including a plurality of relationships between the syndicate device 812 and one or more seller devices 822. The relationship data structure 804 can include one or more relationship entries. The relationship entry can include a syndicate ID, and a plurality of seller IDs 310 associated with the syndicate. The syndicate ID can uniquely identify the syndicate to which the syndicate ID is assigned. The plurality of seller IDs 310 can uniquely identify the plurality of sellers to which the seller ID 310 is assigned. In some implementations, the relationship data structure 804 includes a list of the syndicate IDs and a list of the seller IDs 310. In some implementations, the seller ID 310 list can include two columns. Each index in the first column includes the seller ID 310 value. Each corresponding index in the second column contains a pointer to the memory address of the syndicate ID corresponding to the syndicate that the seller is assigned to. In other implementations, the syndicate ID list can include two columns and indices of second column of the syndicate ID list point to memory addresses of the seller ID 310 corresponding to the seller that is a part of the syndicate. The relationship data structure 804 can be implemented as a database stored in memory.

The inventory management system 202 can be configured to receive, from a client device, a find request 252 for one or more products. The find request 252 can include an identifier identifying the syndicate device 812 and generated via a script executing on an information resource of the syndicate device 812. The find request 252 can include at least one of one or more images and one or more text strings. The information resource of the syndicate device 812 can be a server, a website, a blog, and the like. The information resource can include a find widget 234.

The inventory management system 202 can be configured to determine one or more product tags 314 from the find request 252. The product tags 314 can be stored in the one of the product data structure 204 and the tag universe 214. In response to the find request 252, the inventory management system 202 can be configured to identify a subset of the seller devices 822 based on the one or more product tags 314 and the identifier identifying the syndicate device 812. The inventory management system 202 can be configured to transmit to each seller device 822 of the subset of the seller devices 822 a second request based on the find request 252. The second request can be for fulfilling the find request 252. In some implementations, the inventory management system 202 sends the second request to every seller device 822 corresponding to a seller that is in the syndicate. The inventory management system 202 can read the relationship data structure 804 to determine whether the seller corresponding to the seller device 822 is in the syndicate. In other implementations, the inventory management system 202 can send the second request to the seller devices 822 corresponding to the sellers who meet the following criteria: the sellers are in the syndicate; and the sellers have products which match the product tags 314. The products of the sellers have corresponding product tags 314 in the entries 306 in the product data structure 204. Tag-matching can be implemented by the tag matcher 422 of the find engine 216 of the inventory management system 202. The seller device 822 can respond to the second request about whether the seller device 822 can fulfill the second request. The inventory management system 202 can notify the client device 232 about whether the second request has been fulfilled and whether a product corresponding to the product tags 314 generated from the find request 252 has been located.

The inventory management system 202 can be configured to receive, from one of the client device 232 or the respective seller device 822 of the subset, a third request to perform an electronic transaction for a product corresponding to the respective seller device 822. The third request can identify the client device 232, the respective seller device 822, and the product identified in the third request. In some implementations, the inventory management system 202 receives a user interaction 832 from the client device 232. The user interaction 832 can be an indication that the user interacted with a product on a seller's website. The user interaction 832 can include an interest of a user associated with the client device 232 and time of the interest. In some implementations, the user interaction 832 can include the third request. In some implementations, the third request is a purchase order. In some implementation, the find widget 834 in the syndicate device 812 sends the user interaction 832 to the inventory management system 202.

The inventory management system 202 can be configured to determine that the third request is associated with the syndicate device 812 based on the client device, the respective seller device 822 and the product identified in the third request. In some implementations, the inventory management system 202 determines that the third request is associated with the syndicate device 812 based on receiving one or more of the user interactions 832.

The inventory management system 202 can be configured to update a data structure therein to attribute the electronic transaction to the syndicate device 812. The data structure can include the action attributor 806. The data structure can include a variable for seller credit and a second variable for syndicate credit. Updating the data structure can be responsive to determining that the electronic transaction for the product between the client device 232 and the respective seller device 822 originated from the find request 252 generated via the script executing on the information resource of the syndicate device 812. In some implementations, the inventory management system 202 can notify a third party financial institution, causing the third party financial institution to forward commission to the syndicate device 812.

In some implementations, the inventory management system 202 maintains a database of users associated with client devices 232 and find requests 252. Responsive to uploading new inventory of a new seller device 822, the inventory management system 202 can execute a matching search of the new inventory against unfulfilled find requests 252. The inventory management can provide the results 254 to the new seller device 822.

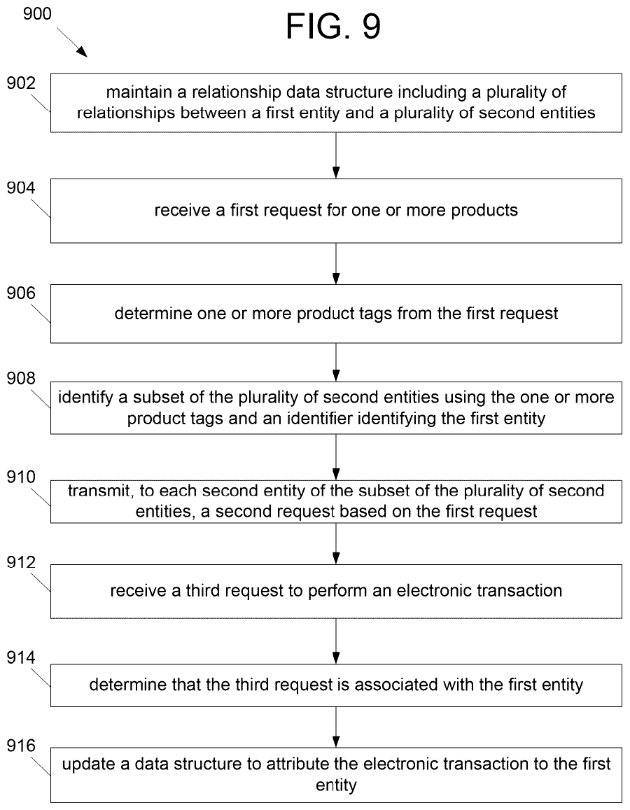

FIG. 9 is a flow chart syndicate lead tracking, according to the implementation of FIG. 8. As a brief overview of the method, the inventory management system 202 can maintain a relationship data structure 804 including a plurality of relationships between a first entity and a plurality of second entities (block 902). The inventory management system 202 can receive a first request for one or more products (block 904). The inventory management system 202 can determine one or more product tags 314 from the first request (block 906). The inventory management system 202 can identify a subset of the plurality of second entities using the one or more product tags 314 and an identifier identifying the first entity (block 908). The inventory management system 202 can transmit, to each second entity of the subset of the plurality of second entities, a second request based on the first request (block 910). The inventory management system 202 can receive a third request to perform an electronic transaction (block 912). The inventory management system 202 can determine that the third request is associated with the first entity (block 914). The inventory management system 202 can update a data structure to attribute the electronic transaction to the first entity (block 916).

In further detail, at block 902, the inventory management system 202 can maintain the relationship data structure 804 including a plurality of relationships between a first entity and a plurality of second entities. The first entity can include the syndicate device 812. The plurality of second entities can include the plurality of seller devices 822. The relationship data structure 804 can include one or more relationship entries. The relationship entry can include a syndicate ID, and a plurality of seller IDs 310 associated with the syndicate. The syndicate ID can uniquely identify the syndicate to which the syndicate ID is assigned. The plurality of seller IDs 310 can uniquely identify the plurality of sellers to which the seller ID 310 is assigned.

At block 904, the inventory management system 202 can receive, from a client device 232, a first request for one or more products. The first request can include a find request 252. find request 252 for one or more products. The find request 252 can include an identifier identifying the first entity and generated via a script executing on an information resource of the first entity. The find request 252 can include at least one of one or more images and one or more text strings. The information resource of the first entity can be a server, a website, a blog, and the like. The information resource can include a find widget 234.

At block 906, the inventory management system 202 can determine one or more product tags 314 from the first request. The product tags 314 can be stored in the one of the product data structure 204 and the tag universe 214. At block 908, in response to the first request, the inventory management system 202 can be configured to identify a subset of the plurality of second entities based on the one or more product tags 314 and the identifier identifying the first entity.

At block 910, the inventory management system 202 can transmit, to each second entity of the subset of the plurality of second entities, a second request based on the first request. The second request can be for fulfilling the first request. In some implementations, the inventory management system 202 sends the second request to each second entity that is a part of the first entity. In other implementations, the inventory management system 202 can send the second request to each second entity which meets the following criteria: the second entity is a part of the first entity; and the second entity has products which match the product tags 314. In some implementations, in response to the inventory management system 202 transmitting the second request, the second entity responds to the second request about whether the second entity can fulfill the second request. The inventory management system 202 can notify the client device 232 about whether the second request has been fulfilled and whether a product corresponding to the product tags 314 generated from the first request has been located.

At block 912, the inventory management system 202 can receive, from one of the client device 232 or the respective second entity of the subset, a third request to perform an electronic transaction for a product corresponding to the respective second entity. The third request can identify the client device 232, the respective seller device 822, and the product identified in the third request. In some implementations, the third request is part of a user interaction 832. The user interaction 832 can be an indication that the user interacted with a product on a seller's website. The user interaction 832 can include an interest of a user associated with the client device 232 and time of the interest.

At block 914, the inventory management system 202 can determine that the third request is associated with the first entity based on the client device, the respective second entity, and the product identified in the third request. In some implementations, the inventory management system 202 determines that the third request is associated with the first entity based on receiving one or more of the user interactions 832.

At block 916, the inventory management system 202 can update a data structure therein to attribute the electronic transaction to the first entity. The data structure can include the action attributor 806. The data structure can include a variable for seller credit and a second variable for syndicate credit. Updating the data structure can be responsive to determining that the electronic transaction for the product between the client device 232 and the respective second device originated from the first request generated via the script executing on the information resource of the first entity.

### Additional Embodiments

Embodiment 1: A method for automatically updating data structures based on assigning electronic tags, comprising:
receiving, by one or more processors of an inventory management system, a request from a device associated with a first entity of a plurality of first entities to import product listings from at least one third-party content server to a product data structure maintained by the inventory management system, the product data structure including a plurality of entries, each entry of the plurality of entries corresponding to a respective product listing associated with a respective first entity and corresponding to one or more third-party content servers;
establishing, by the one or more processors, responsive to the request, a communication session with the at least one third-party content server;
receiving, by the one or more processors, a plurality of product listings associated with the first entity, each product listing identifying a respective product and including one or more images and one or more text strings describing the product;
assigning, by the one or more processors, for each product listing, product tags to the product based on the one or more images and text strings, each product tag included in a tag universe maintained by the inventory management system; and
generating, by the one or more processors, for each product listing, an entry in the product data structure, the entry including the one or more images and the one or more text strings, the product tags assigned to the product, a first identifier identifying the third-party content server from which the product listing was imported, and a second identifier identifying the first entity.

Embodiment 1B: The method of claim Embodiment 1A, further comprising:
identifying a change of a state of the respective product associated with the product listing on the one third-party content server; and
responsive to identifying the change of the state of the respective product associated with the product listing on the one third-party content server, updating a first entry in the product data structure associated with the product listing and updating other product listings on other third-party content servers, the other product listings associated with the respective product.

Embodiment 1C: A system for automatically updating data structures based on assigning electronic tags, comprising:
one or more processors; and
a memory coupled to the one or more processors, the memory comprising computer-readable instructions which when executed by the one or more processors, cause the one or more processors to:
   receive a request from a device associated with a first entity of a plurality of first entities to import product listings from at least one third-party content server to a product data structure maintained by the inventory management system, the product data structure including a plurality of entries, each entry of the plurality of entries corresponding to a respective product listing associated with a respective first entity and corresponding to one or more third-party content servers;
   establish, responsive to the request, a communication session with the at least one third-party content server;
   receive a plurality of product listings associated with the first entity, each product listing identifying a respective product and including one or more images and one or more text strings describing the product;
   assign, for each product listing, product tags to the product based on the one or more images and text strings, each product tag included in a tag universe maintained by the inventory management system; and
   generate, for each product listing, an entry in the product data structure, the entry including the one or more images and the one or more text strings, the product tags assigned to the product, a first identifier identifying the third-party content server from which the product listing was imported, and a second identifier identifying the first entity.

Embodiment 1D: The system of claim Embodiment 1C, the instructions further causing the one or more processors to:
identify a change of a state of the respective product associated with the product listing on the one third-party content server; and
responsive to identifying the change of the state of the respective product associated with the product listing on the one third-party content server, update a first entry in the product data structure associated with the product listing and updating other product listings on other third-party content servers, the other product listings associated with the respective product.

Embodiment 2A: A method for attributing actions to entities in a hierarchical relationship based on request generation, comprising:
maintaining, by one or more processors, a relationship data structure including a plurality of relationships between a first entity and a plurality of second entities;
receiving, by the one or more processors, from a client device, a first request for one or more products, the first request including an identifier identifying the first entity and generated via a script executing on an information resource of the first entity;
determining, by the one or more processors, one or more product tags from the request;
identifying, by the one or more processors, responsive to the request, a subset of the plurality of second entities using the one or more product tags and the identifier identifying the first entity;
transmitting, by the one or more processors, to each second entity of the subset of the plurality of second entities, a second request based on the first request;
receiving, by the one or more processors from one of the client device or a respective second entity of the subset, a third request to perform an electronic transaction for a product corresponding to the respective second entity, the third request identifying the client device, the respective second entity, and the product;
determining, by the one or more processors, that the third request is associated with the first entity based on the client device, the respective second entity, and the product identified in the third request;
receiving, by the one or more processors, an indication of execution of the electronic transaction corresponding to the third request; and
updating, by the one or more processors, a data structure to attribute the electronic transaction to the first entity responsive to determining that the electronic transaction for the product between the client device and the respective second entity originated from the first request generated via the script executing on the information resource of the first entity.

Embodiment 2B: The method of claim Embodiment 2A, wherein updating the data structure comprises:
determining credit to the first entity;
determining credit to the respective second entity;
updating a first variable in the data structure, the first variable corresponding to the credit to the first entity; and
updating a second variable in the data structure, the second variable corresponding to the credit to the respective second entity.

Embodiment 2C: The method of claim Embodiment 2A, further comprising:
responsive to uploading a new inventory of a new second entity, executing a matching search of the new inventory against unfulfilled find requests, the unfulfilled find requests generated via the script executing on the information resource of the first entity; and
providing results of the matching search to the new second entity.

Embodiment 2D: A system for attributing actions to entities in a hierarchical relationship based on request generation, comprising:
one or more processors; and
a memory coupled to the one or more processors, the memory comprising computer-readable instructions which when executed by the one or more processors, cause the one or more processors to:
   receive, from a client device, a first request for one or more products, the first request including an identifier identifying the first entity and generated via a script executing on an information resource of the first entity;
   determine one or more product tags from the request;
   identify, responsive to the request, a subset of the plurality of second entities using the one or more product tags and the identifier identifying the first entity;
   transmit, to each second entity of the subset of the plurality of second entities, a second request based on the first request;
   receive, from one of the client device or a respective second entity of the subset, a third request to perform an electronic transaction for a product corresponding to the respective second entity, the third request identifying the client device, the respective second entity, and the product;
   determine, that the third request is associated with the first entity based on the client device, the respective second entity, and the product identified in the third request;
   receive an indication of execution of the electronic transaction corresponding to the third request; and
   update a data structure to attribute the electronic transaction to the first entity responsive to determining that the electronic transaction for the product between the client device and the respective second entity originated from the first request generated via the script executing on the information resource of the first entity.

Embodiment 2E: The system of claim Embodiment 2D, the instructions further causing the one or more processors to:
determine credit to the first entity;
determine credit to the respective second entity;
update a first variable in the data structure, the first variable corresponding to the credit to the first entity; and
update a second variable in the data structure, the second variable corresponding to the credit to the respective second entity.

Embodiment 2F: The system of claim Embodiment 2D, the instructions further causing the one or more processors to:
responsive to uploading a new inventory of a new second entity, execute a matching search of the new inventory against unfulfilled find requests, the unfulfilled find requests generated via the script executing on the information resource of the first entity; and provide results of the matching search to the new second entity.

Embodiment 3A: A method for managing requests generated via an electronic inspiration gallery, comprising:
providing, by one or more processors of an inventory management system, to a client device, an information resource hosted on one or more servers of the inventory management system including an image provided by an image source entity, the information resource encoded to identify one or more products included in the image and including a script, which when executed, causes the client device to generate a first request to identify products related to a first product of the one or more products to the inventory management system;
receiving, by the one or more processors from the client device, the first request to identify products related to the first product, the first request identifying the first product, information identifying an account associated with the client device, and information identifying the image source entity;
transmitting, by the one or more processors responsive to receiving the first request, to each of a subset of selling entities associated with the inventory management system that are selected based on a product type of the first product, a respective second request to identify products related to the first product;
receiving, by the one or more processors, from a selling entity of the subset, a response to a respective second request, the response identifying at least one related product;
transmitting, by the one or more processors, a notification to the client device indicating a match to the first product; and
updating, by the one or more processors, a data structure to identify the at least one related product to the first product.

Embodiment 3B: A system for managing requests generated via an electronic inspiration gallery, comprising:
one or more processors; and
a memory coupled to the one or more processors, the memory comprising computer-readable instructions which when executed by the one or more processors, cause the one or more processors to:
   provide, to a client device, an information resource hosted on one or more servers of the inventory management system including an image provided by an image source entity, the information resource encoded to identify one or more products included in the image and including a script, which when executed, causes the client device to generate a first request to identify products related to a first product of the one or more products to the inventory management system;
   receive the first request to identify products related to the first product, the first request identifying the first product, information identifying an account associated with the client device, and information identifying the image source entity;
   transmit, responsive to receiving the first request, to each of a subset of selling entities associated with the inventory management system that are selected based on a product type of the first product, a respective second request to identify products related to the first product;
   receive, from a selling entity of the subset, a response to a respective second request, the response identifying at least one related product;
   transmit a notification to the client device indicating a match to the first product; and
   update a data structure to identify the at least one related product to the first product.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method for executing search requests in data structures based on electronic tag matching, comprising:
maintaining, by one or more processors of an inventory management system, a product data structure comprising a plurality of products, each product associated with a first entity;
receiving, by the one or more processors, input information associated with a first product via one or more communication interfaces to at least one third-party content server of a plurality of third-party content servers;
assigning, by the one or more processors, to the first product, a plurality of product tags based on the input information including image of the product;
generating, by the one or more processors, from the image of the first product, using an image recognition algorithm, a plurality of attributes corresponding to the first product;
updating, by the one or more processors, a tag universe including the plurality of product tags maintained by the inventory management system to include at least a subset of the plurality of attributes as new product tags corresponding to the first product;
updating, by the one or more processors, the product data structure to include the first product and the new product tags corresponding to the first product;
receiving, by the one or more processors from a client device, a query comprising at least one of an image or a text string;
selecting, by the one or more processors, from the updated tag universe, a plurality of first tags for the query responsive to parsing the query;
assigning, by the one or more processors, to each first tag of the plurality of first tags, a respective weight based on a frequency count of a corresponding attribute;
executing, by the one or more processors, a search using respective weights assigned to the plurality of first tags to identify the first product of the plurality of products responsive to matching the plurality of first tags to the new products tags of the first product;
identifying, by the one or more processors, the first entity associated with the first product; and
providing, by the one or more processors, for presentation at the client device responsive to the query, an identification of the first product and the first entity.

2. The method of claim 1, further comprising receiving a notification generation selection from a device associated with the first entity, the notification generation selection indicating automatic presentation without notification.

3. The method of claim 1, further comprising:
receiving a notification generation selection from a device associated with the first entity, the notification generation selection indicating automatic presentation with notification; and
sending, by the one or more processors, for presentation at the device associated with the first entity, a notification of the client device receiving the identification of the first product and the first entity.

4. The method of claim 1, further comprising:
receiving a notification generation selection from a device associated with the first entity, the notification generation selection indicating seller confirmed notification; and
sending, by the one or more processors, for presentation at the device associated with the first entity, an input requesting approval of the client device receiving the identification of the first product and the first entity,
wherein providing, by the one or more processors, for presentation at the client device responsive to the query, the identification of the first product and the first entity is responsive to receiving indication of the approval from the device associated with the first entity.

5. The method of claim 1, wherein selecting the plurality of first tags comprises:
responsive to the query including the text string, parsing the text string into keywords and matching the keywords to pre-defined keywords associated with the plurality of first tags; and
responsive to the query including the image, assigning a pattern class to the image and mapping the pattern class to the plurality of first tags.

6. The method of claim 1, wherein selecting the plurality of first tags comprises:
using an object detection algorithm to identify one or more objects from the image;
identifying a primary object from the image;
determining a type of product corresponding to the primary object;
identifying, using the product data structure, a plurality of attributes stored for candidate products that correspond to the determined type of product; and
generating, for the primary object, a plurality of tags corresponding to the plurality of attributes responsive to identifying the plurality of attributes stored for candidate products.

7. The method of claim 6, wherein the plurality of attributes includes a color of the product, a dimension of the product, and a time period associated with the product.

8. The method of claim 6, wherein responsive to determining that the primary object is a first product type, identifying a first plurality of attributes and responsive to determining that the primary object is a second product type, identifying a second plurality of attributes different from the first plurality of attributes.

9. The method of claim 6, wherein each attribute of the plurality of attributes is assigned a respective weight to optimize a search process, wherein the respective weight is based on one of a unique number of different values for the attribute or a frequency count of a most common value for the attribute.

10. The method of claim 6, wherein responsive to determining that the query is a text query, rearranging the query according to a standard format based on words included in the text query.

11. A system for executing search requests in data structures based on electronic tag matching, comprising:
one or more processors of an inventory management system; and
a memory coupled to the one or more processors, the memory comprising computer-readable instructions which when executed by the one or more processors, cause the one or more processors to:
maintain a product data structure comprising a plurality of products, each product associated with a first entity;
receive input information associated with a first product via one or more communication interfaces to at least one third-party content server of a plurality of third-party content servers;
assign, to the first product, a plurality of product tags based on the input information including image of the product;
generate, from the image of the first product, using an image recognition algorithm, a plurality of attributes corresponding to the first product;
update a tag universe including the plurality of product tags maintained by the inventory management system to include at least a subset of the plurality of attributes as new product tags corresponding to the first product;
update the product data structure to include the first product and the new product tags corresponding to the first product;
receive, from a client device, a query comprising at least one of an image or a text string;
select, from the updated tag universe, a plurality of first tags for the query responsive to parsing the query;
assign, to each first tag of the plurality of first tags, a respective weight based on a frequency count of a corresponding attribute;
execute a search using respective weights assigned to the plurality of first tags to identify the first product of the plurality of products responsive to matching the plurality of first tags to the new products tags of the first product;
identify the first entity associated with the first product; and
provide, for presentation at the client device responsive to the query, an identification of the first product and the first entity.

12. The system of claim 11, the instructions further causing the one or more processors to receive a notification generation selection from a device associated with the first entity, the notification generation selection indicating automatic presentation without notification.

13. The system of claim 11, the instructions further causing the one or more processors to:
receive a notification generation selection from a device associated with the first entity, the notification generation selection indicating automatic presentation with notification; and
send, for presentation at the device associated with the first entity, a notification of the client device receiving the identification of the first product and the first entity.

14. The system of claim 11, the instructions further causing the one or more processors to:
receive a notification generation selection from a device associated with the first entity, the notification generation selection indicating seller confirmed notification; and
send, for presentation at the device associated with the first entity, an input requesting approval of the client device receiving the identification of the first product and the first entity,
wherein providing, for presentation at the client device responsive to the query, the identification of the first product and the first entity is responsive to receiving indication of the approval from the device associated with the first entity.

15. The system of claim 11, the instructions further causing the one or more processors to:
responsive to the query including the text string, parse the text string into keywords and matching the keywords to pre-defined keywords associated with the plurality of first tags; and
responsive to the query including the image, assign a pattern class to the image and mapping the pattern class to the plurality of first tags.

16. The system of claim 11, wherein to generate the plurality of first tags, the one or more processors are further configured to:
use an object detection algorithm to identify one or more objects from the image;
identify a primary object from the image;
determine a type of product corresponding to the primary object;
identify, using the product data structure, a plurality of attributes stored for candidate products that correspond to the determined type of product; and
generate, for the primary object, a plurality of tags corresponding to the plurality of attributes responsive to identifying the plurality of attributes stored for candidate products.

17. The system of claim 16, wherein the plurality of attributes includes a color of the product, a dimension of the product, and a time period associated with the product.

18. The system of claim 16, wherein responsive to determining that the primary object is a first product type, the one or more processors are configured to identify a first plurality of attributes and responsive to determining that the primary object is a second product type, the one or more processors are configured to identify a second plurality of attributes different from the first plurality of attributes.

19. The system of claim 16, wherein each attribute of the plurality of attributes is assigned a respective weight to optimize a search process, wherein the respective weight is based on one of a unique number of different values for the attribute or a frequency count of a most common value for the attribute.

20. The system of claim 16, wherein responsive to determining that the query is a text query, the one or more processors are configured to rearrange the query according to a standard format based on words included in the text query.
